(19) United States
(12) Patent Application Publication
(10) Pub. No.: US 2024/0054112 A1
(43) Pub. Date: Feb. 15, 2024

(54) DATABASE VIEW GENERATOR FOR SAFE OBJECT NAMES

(71) Applicant: SAP SE, Walldorf (DE)

(72) Inventor: Alexander OCHER, San Jose, CA (US)

(21) Appl. No.: 18/176,341

(22) Filed: Feb. 28, 2023

Related U.S. Application Data
(60) Provisional application No. 63/397,071, filed on Aug. 11, 2022.

(51) Int. Cl. G06F 16/21; G06F 16/25

(52) U.S. Cl. CPC G06F 16/213; G06F 16/252

(57) ABSTRACT

Disclosed herein are system, method, and computer program product embodiments for allowing a software application subject to restrictions on table or column names work with a database management system (DBMS). An embodiment operates by determining that a table name or one or more column names of a table used in the DBMS violate one or more predefined rules for the software application. In response to the determining, the embodiment then creates a view for the table such that a view name of the view or the one or more column names of the view satisfy the one or more predefined rules for the software application.

### CROSS-REFERENCE TO RELATED APPLICATIONS

This application claims the benefit and priority to U.S. Provisional Patent Application No. 63/397,071, filed Aug. 11, 2022, entitled “Database View Generator For Safe Object Names,” which is incorporated herein by reference in its entirety.

### BACKGROUND

Older software was often designed to work with older database management systems (DBMSs). These older DBMSs often had many restrictions on table and/or column names. For example, many older DBMSs restricted table and/or column names to uppercase. In addition, developing new software to work with DBMs is often challenging because selected table and/or column names often conflict with other standards. For example, such software may use names that include a slash that is a special character for Extensible Markup Language (XML) objects.

But newer DBMs often have less restrictions on table and/or columns names. For example, newer DBMs may allow any valid character (e.g., the space character). In addition, newer DBMSs may allow keywords or reserved words to be used in table and/or column names.

### BRIEF DESCRIPTION OF THE DRAWINGS

The accompanying drawings are incorporated herein and form a part of the specification.

FIG. 1 is a block diagram of a system that allows software subject to restrictions on table and/or column names work with database management systems (DBMSs) that have less restrictions on table and/or column names, according to some embodiments.

FIG. 2 is a flowchart illustrating a process for allowing software subject to restrictions on table and/or column names work with DBMSs that have less restrictions on table and/or column names, according to some embodiments.

FIG. 3 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for allowing older software to work with newer database management systems (DBMSs) that have less restrictions on table and/or column names. Moreover, these embodiments simplify the development of new software to work with DBMSs while also enabling such software to not conflict with other standards.

Older software was often designed to work with older DBMS. These older DBMSs often had many restrictions on table and/or column names. For example, many older DBMSs restricted table and/or column names to uppercase. In addition, developing new software to work with DBMSs is often challenging because selected table and/or column names often conflict with other standards. For example, such software may use names that include a slash that is a special character for Extensible Markup Language (XML) objects.

But newer DBMSs often have less restrictions on table and/or columns names. For example, newer DBMSs may allow any valid character (e.g., the space character) in table and/or column names. In addition, newer DBMSs may allow keywords or reserved words to be used in table and/or column names. There is a need to make older software that cannot be changed work with these newer DBMSs. There is also a need to simplify the development of new software by providing names that do not conflict with other standards (e.g., XML).

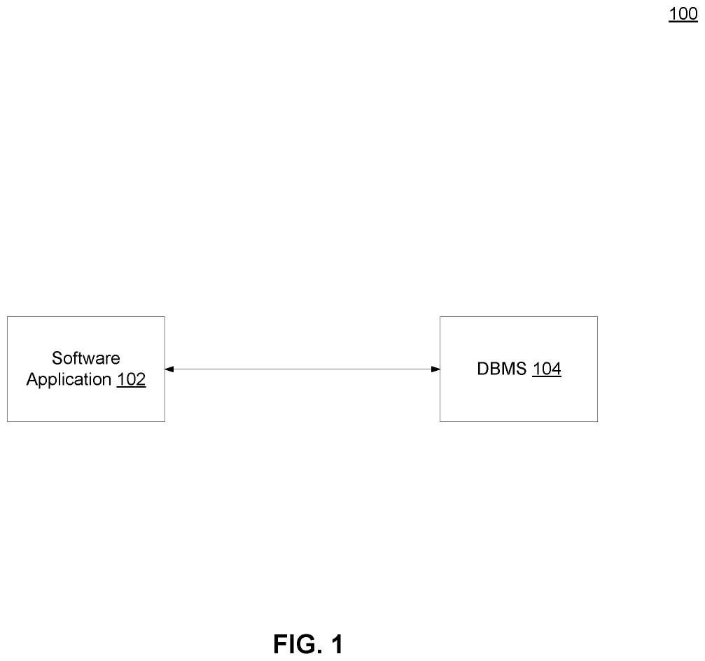

FIG. 1 is a block diagram of a system 100 that allows software subject to restrictions on table and/or column names work with DBMSs that have less restrictions on table and/or column names, according to some embodiments. System 100 can include software application 102 and DBMS 104.

Software application 102 can be any software application that stores, manipulates, and retrieves data in DBMS 104. Software application 102 may be older software that cannot be changed to work with newer DBMSs that have less restrictions on table and/or column names (e.g., DBMS 104). Software application 102 can be executed on a desktop computer, laptop, tablet, smartphone, server, cloud computing system, computer cluster, virtual machine, container, or other device as would be appreciated by a person of ordinary skill in the art.

DBMS 104 can be any DBMS that is used to store, retrieve, and run queries on data. DBMS 104 can be executed on a server, cloud computing system, computer cluster, virtual machine, container, desktop computer, laptop, tablet, smartphone, or other device as would be appreciated by a person of ordinary skill in the art. DBMS 104 may be DBMS that has less restrictions on table and/or column names. For example, DBMS 104 may allow any valid character (e.g., the space character) in table and/or column names. DBMS 104 may also allow keywords or reserved words to be used in table and/or column names.

As shown in FIG. 1, software application 102 may be communicatively coupled to DBMS 104. For example, software 102 may communicate with DBMS 104 over a communications path, which may be wired and/or wireless (or a combination thereof), and which may include any combination of LANs, WANs, the Internet, etc. Control logic and/or data may be transmitted to and from DBMS 104 via the communication path.

To make software application 102 work with DBMS 104 despite software application 102 having restrictions on database object names, DBMS 104 can use a tool to create views for database objects that violate rules for database object names for software application 102. For example, to make software application 102 work with DBMS 104 despite software application 102 having restrictions on table and/or column names, DBMS 104 can use the tool to create views for tables that violate rules for table and/or column names for software application 102. For example, if a table has a column that uses a reserved word or contains a slash, and therefore violates a table and/or column naming rule for software application 102, DBMS 104 can create a view with a normalized name that does not violate such a rule for software application 102. The generated view can then be used in place of the table being used for extraction or loading by software application 102. Alternatively, if there are no columns violate the rules of software application 102, DBMS 104 can skip creating a view.

DBMS 104 can create the view's name based on one or more rules. For example, DBMS 104 can create the view's name as vn_<object_name> where object_name is the name of the database object that the view represents and vn stands for view normalized. Similarly, DBMS 104 can create the view's name as vn_<table_name> where table_name is the name of the table that the view represents and vn stands for view normalized. The one or more rules may be predefined according the restrictions on database object names (e.g., table and/or column names) for software application 102. A user of software application 102 may define the one or more rules. A developer of software application 102 may also define the one or more rules.

DBMS 104's tool can create the view such that it is in a one-to-one correspondence with the table being used for extraction or loading by software application 102. DBMS 104's tool can create the view such that there is no change in the number, type, data length, and/or order of the columns from the table being used for extraction or loading by software application 102. For example, if the third column in the original table was a character field with length 14 characters (e.g., VARCHAR(14)), the third column of the generated view can also be a character field with length 14 characters (e.g., VARCHAR(14)).

DBMS 104's tool can also create the view such that a column's name in the generated view is the same length as the corresponding column in the table being used for extraction or loading by software application 102. This can avoid the resulting column name exceeding a maximum allowed length in DBMS 104. This can also avoid the resulting column name exceeding a maximum allowed length in third-party software (e.g., software application 102) that interfaces with DBMS 104.

DBMS 104's tool can also create the view such that is represents multiple tables being used for extraction or loading by software application 102. DBMS 104's tool can create the view in various other ways as would be appreciated by a person of ordinary skill in the art.

DBMS 104's tool can modify system information such as referential integrity in such way as to make it interchangeable to use either the original table or the generated view for the table.

DBMS 104's tool can work in at least three modes. First, DBMS 104's tool can work stand-alone. Second, DBMS 104's tool can be trigger based. Finally, DBMS 104's tool can combine both modes. For example, DBMS 104's tool can initially be run stand-alone, and then later switched to trigger mode.

DBMS 104's tool can be implemented as procedural code in DBMS 104. For example, DBMS 104's tool can be implemented as a stored procedure. The procedural code of DBMS 104's tool may be database dependent. The procedural code of DBMS 104's tool may be also be database independent. DBMS 104's tool can be implemented in various other ways as would be appreciated by a person of ordinary skill in the art.

The procedural code of DBMS 104's tool may be Structured Query Language (SQL) code. The procedural code of DBMS 104's tool may be database dependent SQL code. The procedural code of DBMS 104's tool may be implemented using various other programming languages as would be appreciated by a person of ordinary skill in the art.

In stand-alone mode, DBMS 104's tool can check metadata tables describing the table and/or column names being used in DBMS 104. For example, DBMS 104's tool may check the SYS.TABLES and SYS.COLUMNS tables, respectively. DBMS 104's tool may check other metadata tables as would be appreciated by a person of ordinary skill in the art. DBMS 104's tool can also check the table and column names being used in DBMS 104 in various other ways as would be appreciated by a person of ordinary skill in the art.

DBMS 104's tool may check the metadata tables during an initial run. DBMS 104's tool may also check the metadata tables according to a schedule. For example, DBMS 104's tool can check the metadata tables periodically (e.g., every hour or day).

DBMS 104's tool can check the metadata tables to see if anything (e.g., a table name, a column name, or other database object name) violates one or more rules. For example, DBMS 104's tool can check the metadata tables to see if anything (e.g., a table name, a column name, or other database object name) includes a space character, a slash character, or a reserved word. DBMS 104's tool can also check if only a subset of table names and/or column names violate the one or more rules. For example, DBMS 104's tool can check if table names starting with ‘M’ violate the one or more rules. A user may configure DBMS 104's tool to check if only a subset of table names and/or column names violates the one or more rules.

If DBMS 104's tool determines that something violates the one or more rules, it can create a view for the associated table if the view does not exist yet. For example, DBMS 104's tool can replace a character in a name of the table that violates a rule of the one or more rules with another character in a corresponding name of the view, wherein the other character does not violate the one or more rules. Similarly, DBMS 104's tool can replace a character in a column name of the table that violates a rule of the one or more rules with another character in a corresponding column name of the view, wherein the other character does not violate the one or more rules. Similarly, DBMS 104's tool can replace a character in a database object associated with the table that violates a rule of the one or more rules with another character in a corresponding database object associated with the view, wherein the other character does not violate the one or more rules.

DBMS 104's tool can create the view such that a column's name in the generated view is the same length as the corresponding column in the table being used for extraction or loading by software application 102.

DBMS's 104 tool can replace offending characters (e.g., space or slash characters) in the name with underscores (or another non-offending character as would be appreciated by a person of ordinary skill in the art) and then check for name collision (e.g., the same name is used for different things in two separate areas that are joined, merged, or otherwise go from occupying separate namespaces to sharing one). If a collision is found, DBMS 104 can further modify the name by replacing characters with underscores (or another non-offending character as would be appreciated by a person of ordinary skill in the art) starting from the beginning or end of the name. DBMS 104 can modify the name until the name collision is resolved. For example, if a modified column name of the view collides with another column name of the view, DBMS 104 can further modify the column name by replacing characters with underscores (or another non-offending character as would be appreciated by a person of ordinary skill in the art) starting from the beginning or end of the column name. Similarly, if a modified view name collides with another view name (or table name), DBMS 104 can further modify the view name by replacing characters with underscores (or another non-offending character as would be appreciated by a person of ordinary skill in the art) starting from the beginning or end of the view name.

DBMS 104's tool can also create the view such that there is no change in the number, type, data length, and/or order of the columns from the table being used for extraction or loading by software application 102. In other words, DBMS 104's tool can create the view such that columns in the view match the columns from the table in terms of number, type, data length, and/or order. For example, if the third column in the original table was a character field with length 14 characters (e.g., VARCHAR(14)), the third column of the generated view can also be a character field with length 14 characters (e.g., VARCHAR(14)).

In trigger mode, DBMS 104's tool can be set up as database trigger(s) on the metadata tables for table and column names. A database trigger can execute procedural code (e.g., a stored procedure). The procedural code (e.g., a stored procedure) may be SQL code. The procedural code may be implemented using various other programming languages as would be appreciated by a person of ordinary skill in the art.

In trigger mode, when a new record is inserted or an update is made to DBMS 104, a database trigger can be executed that checks the metadata tables to see if anything (e.g., a table name and/or a column name) violates one or more rules. The database trigger can also check the table and/or column names being used in DBMS 104 in various other ways as would be appreciated by a person of ordinary skill in the art.

If the database trigger code determines that something violates the one or more rules, it can create a view for the associated table if the view does not exist yet. The database trigger code can create the view such that a column's name in the generated view is the same length as the corresponding column in the table being used for extraction or loading by software application 102. For example, the database trigger code can replace offending characters (e.g., space or slash characters) in the name with underscores (or another non-offending character as would be appreciated by a person of ordinary skill in the art) and then check for name collision. If a collision is found, the database trigger code can further modify the name by replacing characters with underscores starting from the beginning or end of the name.

The database trigger code can also create the view such that there is no change in the number, type, data length, and/or order of the columns from the table being used for extraction or loading by software application 102. For example, if the third column in the original table was a character field with length 14 characters (e.g., VARCHAR(14)), the third column of the generated view can also be a character field with length 14 characters (e.g., VARCHAR(14)).

In combined mode, DBMS 104's tool can be initially run in stand-alone mode as discussed above. After performing an initial run, DBMS 104's tool can then be run in trigger mode as discussed above. This combined mode approach can improve efficiency by eliminating regenerating views that do not need to be regenerated because there was no change to the underlying table and/or its column names.

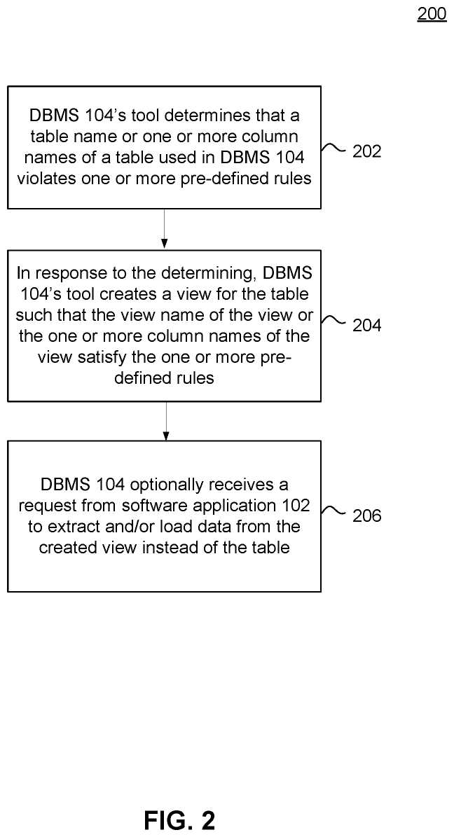

FIG. 2 is a flowchart for a method 200 for allowing software subject to restrictions on table and/or column names work with DBMSs that have less restrictions on table and/or column names, according to an embodiment. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art.

Method 200 shall be described with reference to FIG. 1. However, method 200 is not limited to that example embodiment.

In 202, DBMS 104's tool determines that a table name or one or more column names of a table used in DBMS 104 violates one or more rules. The one or more rules may be predefined according the restrictions on table and/or column names for software application 102. A user of software application 102 may define the one or more rules. A developer of software application 102 may also define the one or more rules.

DBMS 104's tool may check metadata tables (e.g., SYS.TABLES and/or SYS.COLUMNS) to see if anything (e.g., a table name, a column name, or other database object name) violates the one or more rules. For example, DBMS 104's tool can check the metadata tables to see if anything (e.g., a table name, a column name, or other database object name) includes a space character, a slash character, or a reserved word. DBMS 104's tool may check the metadata tables independent of a database trigger (e.g., in stand-alone mode). DBMS 104's tool may also check the metadata tables in response to execution of a database trigger. For example, DBMS 104's tool may check the metadata tables in response to a new record being inserted or an update being made to DBMS 104. DBMS 104's tool can also check the table and column names being used in DBMS 104 in various other ways as would be appreciated by a person of ordinary skill in the art.

DBMS 104's tool can also check if only a subset of table names and/or column names violate the one or more rules. For example, DBMS 104's tool can check if table names starting with ‘M’ violate the one or more rules. A user may configure DBMS 104's tool to check if only a subset of table names and/or column names violates the one or more rules.

In 204, in response to 202, DBMS 104's tool creates a view for the table such that the view name of the view, or the one or more column names of the view, satisfy the one or more rules. Software application 102 may be subject to these one or more rules for table and/or column names. DBMS 104's tool can create the view for the table if the view does not exist yet.

DBMS 104's tool can replace a character in a name of the table that violates a rule of the one or more rules with another character in a corresponding name of the view, wherein the other character does not violate the one or more rules. Similarly, DBMS 104's tool can replace a character in a column name of the table that violates a rule of the one or more rules with another character in a corresponding column name of the view, wherein the other character does not violate the one or more rules. Similarly, DBMS 104's tool can replace a character in a database object associated with the table that violates a rule of the one or more rules with another character in a corresponding database object associated with the view, wherein the other character does not violate the one or more rules.

DBMS 104's tool can create the view such that a column's name in the generated view is the same length as the corresponding column in the table being used for extraction or loading by software application 102.

DBMS's 104 tool can replace offending characters (e.g., space or slash characters) in the name with underscores (or another non-offending character as would be appreciated by a person of ordinary skill in the art) and then check for name collision (e.g., the same name is used for different things in two separate areas that are joined, merged, or otherwise go from occupying separate namespaces to sharing one). If a collision is found, DBMS 104 can further modify the name by replacing characters with underscores (or another non-offending character as would be appreciated by a person of ordinary skill in the art) starting from the beginning or end of the name. DBMS 104 can modify the name until the name collision is resolved. For example, if a modified column name of the view collides with another column name of the view, DBMS 104 can further modify the column name by replacing characters with underscores (or another non-offending character as would be appreciated by a person of ordinary skill in the art) starting from the beginning or end of the column name. Similarly, if a modified view name collides with another view name (or table name), DBMS 104 can further modify the view name by replacing characters with underscores (or another non-offending character as would be appreciated by a person of ordinary skill in the art) starting from the beginning or end of the view name.

DBMS 104's tool can also create the view such that there is no change in the number, type, data length, and/or order of the columns from the table. In other words, DBMS 104's tool can create the view such that columns in the view match the columns from the table in terms of number, type, data length, and/or order. For example, if the third column in the original table was a character field with length 14 characters (e.g., VARCHAR(14)), the third column of the generated view can also be a character field with length 14 characters (e.g., VARCHAR(14)).

In 206, DBMS 104 optionally receives a request from software application 102 to extract and/or load data from the created view instead of the table. This allows software application 102 to work with DBMS 104 despite having restrictions on table and/or column names.

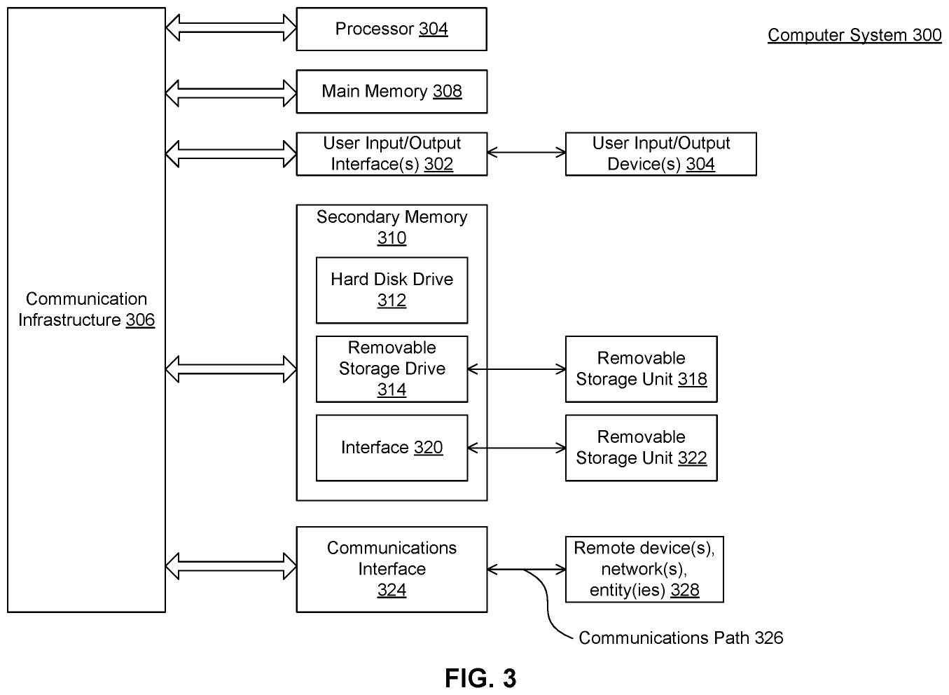

Various embodiments may be implemented, for example, using one or more well-known computer systems, such as computer system 300 shown in FIG. 3. One or more computer systems 300 may be used, for example, to implement any of the embodiments discussed herein, as well as combinations and sub-combinations thereof.

Computer system 300 may include one or more processors (also called central processing units, or CPUs), such as a processor 304. Processor 304 may be connected to a communication infrastructure or bus 306.

Computer system 300 may also include user input/output device(s) 303, such as monitors, keyboards, pointing devices, etc., which may communicate with communication infrastructure 306 through user input/output interface(s) 302.

One or more of processors 304 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 300 may also include a main or primary memory 308, such as random access memory (RAM). Main memory 308 may include one or more levels of cache. Main memory 308 may have stored therein control logic (i.e., computer software) and/or data.

Computer system 300 may also include one or more secondary storage devices or memory 310. Secondary memory 310 may include, for example, a hard disk drive 312 and/or a removable storage device or drive 314. Removable storage drive 314 may be a floppy disk drive, a magnetic tape drive, a compact disk drive, an optical storage device, tape backup device, and/or any other storage device/drive.

Removable storage drive 314 may interact with a removable storage unit 318. Removable storage unit 318 may include a computer usable or readable storage device having stored thereon computer software (control logic) and/or data. Removable storage unit 318 may be a floppy disk, magnetic tape, compact disk, DVD, optical storage disk, and/any other computer data storage device. Removable storage drive 314 may read from and/or write to removable storage unit 318.

Secondary memory 310 may include other means, devices, components, instrumentalities or other approaches for allowing computer programs and/or other instructions and/or data to be accessed by computer system 300. Such means, devices, components, instrumentalities or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 300 may further include a communication or network interface 324. Communication interface 324 may enable computer system 300 to communicate and interact with any combination of external devices, external networks, external entities, etc. (individually and collectively referenced by reference number 328). For example, communication interface 324 may allow computer system 300 to communicate with external or remote devices 328 over communications path 326, which may be wired and/or wireless (or a combination thereof), and which may include any combination of LANs, WANs, the Internet, etc. Control logic and/or data may be transmitted to and from computer system 300 via communication path 326.

Computer system 300 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 3. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method for allowing a software application subject to restrictions on table names or column names work with a database management system (DBMS), comprising:
determining that a table name or one or more column names of a table used in the DBMS violate one or more predefined rules for the software application; and
in response to the determining, creating a view for the table such that a view name of the view or the one or more column names of the view satisfy the one or more predefined rules for the software application.

2. The computer implemented method of claim 1, wherein the creating the view comprises:
creating the view for the table such that columns in the view match the one or more columns in the table in terms of number, type, data length, and order.

3. The computer implemented method of claim 1, wherein the determining that the table name or the one or more column names of the table used in the DBMS violate the one or more predefined rules comprises:
determining that the table name or the one or more column names of the table used in the DBMS violate the one or more predefined rules according to a schedule.

4. The computer implemented method of claim 1, wherein the determining that the table name or the one or more column names of the table used in the DBMS violate the one or more predefined rules comprises:
determining that the table name or the one or more column names of the table used in the DBMS violate the one or more predefined rules in response to the DBMS executing a database trigger.

5. The computer implemented method of claim 1, further comprising:
identifying the table name or the one or more column names of the table used in the DBMS by analyzing one or more metadata tables in the DBMS.

6. The computer implemented method of claim 1, wherein the creating the view comprises:
replacing a character in a column name of the table that violates a predefined rule of the one or more predefined rules with another character in a corresponding column name of the view, wherein the other character does not violate the one or more predefined rules.

7. The computer implemented method of claim 1, wherein the creating the view comprises:
determining a presence of a name collision between a column name of the view and another column of the view; and
modifying the column name of the view by replacing characters of the column name with underscores starting from a beginning or end of the column name of the view until there is no name collision between the column name of the view and the other column of the view.

8. A system for allowing a software application subject to restrictions on table names or column names work with a database management system (DBMS), comprising:
a memory; and
at least one processor coupled to the memory and configured to:
determine that a table name or one or more column names of a table used in the DBMS violate one or more predefined rules for the software application; and
in response to the determining, create a view for the table such that a view name of the view or the one or more column names of the view satisfy the one or more predefined rules for the software application.

9. The system of claim 8, wherein to create the view, the at least one processor is configured to:
create the view for the table such that columns in the view match the one or more columns in the table in terms of number, type, data length, and order.

10. The system of claim 8, wherein to determine that the table name or the one or more column names of the table used in the DBMS violate the one or more predefined rules, the at least one processor is configured to:
determine that the table name or the one or more column names of the table used in the DBMS violate the one or more predefined rules according to a schedule.

11. The system of claim 8, wherein to determine that the table name or the one or more column names of the table used in the DBMS violate the one or more predefined rules, the at least one processor is configured to:
determine that the table name or the one or more column names of the table used in the DBMS violate the one or more predefined rules in response to the DBMS executing a database trigger.

12. The system of claim 8, wherein the at least one processor is further configured to:
identify the table name or the one or more column names of the table used in the DBMS by analyzing one or more metadata tables in the DBMS.

13. The system of claim 8, wherein to create the view, the at least one processor is configured to:
replace a character in a column name of the table that violates a predefined rule of the one or more predefined rules with another character in a corresponding column name of the view, wherein the other character does not violate the one or more predefined rules.

14. The system of claim 8, wherein to create the view, the at least one processor is configured to:
determine a presence of a name collision between a column name of the view and another column of the view; and
modify the column name of the view by replacing characters of the column name with underscores starting from a beginning or end of the column name until there is no name collision between the column name of the view and the other column of the view.

15. A non-transitory computer-readable medium having instructions stored thereon that, when executed by at least one computing device, cause the at least one computing device to perform operations comprising:
determining that a table name or one or more column names of a table used in a database management system (DBMS) violate one or more predefined rules for a software application; and
in response to the determining, creating a view for the table such that a view name of the view or the one or more column names of the view satisfy the one or more predefined rules for the software application.

16. The non-transitory computer-readable medium of claim 15, wherein the creating the view comprises:
creating the view for the table such that columns in the view match the one or more columns in the table in terms of number, type, data length, and order.

17. The non-transitory computer-readable medium of claim 15, wherein the determining that the table name or the one or more column names of the table used in the DBMS violate the one or more predefined rules comprises:
determining that the table name or the one or more column names of the table used in the DBMS violate the one or more predefined rules according to a schedule.

18. The non-transitory computer-readable medium of claim 15, wherein the determining that the table name or the one or more column names of the table used in the DBMS violate the one or more predefined rules comprises:
determining that the table name or the one or more column names of the table used in the DBMS violate the one or more predefined rules in response to the DBMS executing a database trigger.

19. The non-transitory computer-readable medium of claim 15, wherein the creating the view comprises:
replacing a character in a column name of the table that violates a predefined rule of the one or more predefined rules with another character in a corresponding column name of the view, wherein the other character does not violate the one or more predefined rules.

20. The non-transitory computer-readable medium of claim 15, wherein the creating the view comprises:
determining a presence of a name collision between a column name of the view and another column of the view; and
modifying the column name of the view by replacing characters of the column name with underscores starting from a beginning or end of the column name until there is no name collision between the column name of the view and the other column of the view.
